(19) United States
(12) Patent Application Publication
(10) Pub. No.: US 2008/0267287 A1
(43) Pub. Date: Oct. 30, 2008

(54) SYSTEM AND METHOD FOR IMPLEMENTING FAST TUNE-IN WITH INTRA-CODED REDUNDANT PICTURES

(75) Inventor: Miska Hannuksela, Ruutana (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/108,473

(22) Filed: Apr. 23, 2008

Related U.S. Application Data
(60) Provisional application No. 60/913,773, filed on Apr. 24, 2007.

(51) Int. Cl. H04N 7/32

(52) U.S. Cl. 375/240.12; 375/E07.243

(57) ABSTRACT

A system and method by which instantaneous decoding refresh (IDR)/intra pictures that enable one to tune in or randomly access a media stream are included within a “normal” bitstream as redundant coded pictures. In various embodiments, each intra picture for tune-in is provided as a redundant coded picture, in addition to the corresponding primary inter-coded picture.

### CROSS-REFERENCE TO RELATED APPLICATIONS

The present application claims priority to U.S. Provisional Patent Application No. 60/913,773, filed Apr. 24, 2007.

### FIELD OF THE INVENTION

The present invention relates generally to video encoding and decoding. More particularly, the present invention relates to the random accessing of a media stream that has been encoded.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Advanced Video Coding (AVC), also know as H.264/AVC, is a video coding standard developed by the Joint Video Team (JVT) of ITU-T Video Coding Expert Group (VCEG) and ISO/IEC Motion Picture Expert Group (MPEG). AVC includes the concepts of a Video Coding Layer (VCL) and a Network Abstraction Layer (NAL). The VCL contains the signal processing functionality of the codec—mechanisms such as transform, quantization, motion-compensated prediction, and loop filters. A coded picture consists of one or more slices. The NAL encapsulates each slice generated by the VCL into one or more NAL units.

Scalable Video Coding (SVC) provides scalable video bitstreams. A scalable video bitstream contains a non-scalable base layer and one or more enhancement layers. An enhancement layer may enhance the temporal resolution (i.e. the frame rate), the spatial resolution, and/or the quality of the video content represented by the lower layer or part thereof. In the SVC extension of AVC, the VCL and NAL concepts were inherited.

Multi-view Video Coding (MVC) is another extension of AVC. An MVC encoder takes input video sequences (called different views) of the same scene captured from multiple cameras and outputs a single bitstream containing all the coded views. MVC also inherited the VCL and NAL concepts.

Real-time Transport Protocol (RTP) is widely used for real-time transport of timed media such as audio and video. In RTP transport, media data is encapsulated into multiple RTP packets. A RTP payload format for RTP transport of AVC video is specified in IETF Request for Comments (RFC) 3984, which is available from www.rfc-editor.org/rfc/rfc3984.txt. For AVC video transport using RTP, each RTP packet contains one or more NAL units.

Forward Error Correction (FEC) is a system that introduces redundant data, which allow the receivers to detect and correct errors. The advantage of forward error correction is that retransmission of data can often be avoided, at the cost of higher bandwidth requirements on average. For example, in a systematic FEC arrangement, the sender calculates a number of redundant bits over the to-be-protected bits in the various to-be-protected media packets. These redundant bits are added to FEC packets, and both the media packets and the FEC packets are transmitted. At the receiver, the FEC packets can be used to check the integrity of the media packets and to reconstruct media packets that may be missing. The media packets and the FEC packets which are protecting those media packets are referred to herein as FEC frames or FEC blocks.

Most FEC systems that are intended for erasure protection allow the selection of the number of to-be-protected media packets and the number of FEC packets to be chosen adaptively in order to select the strength of the protection and the delay constraints of the FEC subsystem. Variable FEC frame sizes are discussed, for example, in the Network Working Group's Request for Comments (RFC) 2733, which can be found at www.ietf.org/rfc/rfc2733.txt, and in the U.S. Pat. No. 6,678,855, issued Jan. 13, 2004.

Packet-based FEC as discussed above requires a synchronization of the receiver to the FEC frame structure in order to take advantage of the FEC. In other words, a receiver has to buffer all media and FEC packets of a FEC frame before error correction can commence.

The MPEG-2 and H.264/AVC standards, as well as many other video coding standards and methods, use intra-coded pictures (also referred to as intra pictures and “I” pictures) and inter-coded pictures (also referred to as inter pictures) in order to compress video. An intra-coded picture is a picture that is coded using information present only in the picture itself and does not depend on information from other pictures. Such pictures provide a mechanism for random access into the compressed video data, as the picture can be decoded without having to reference another picture.

An SI picture, specified in H.264/AVC, is a special type of an intra picture for which the decoding process contains additional steps in order to ensure that the decoded sample values of an SI picture can be identical to a specially coded inter picture, referred to as a SP picture.

H.264/AVC and many other video coding standards allow for the dividing of a coded picture into slices. Many types of prediction can be disabled across slice boundaries. Thus, slices can be used as a way to split a coded picture into independently decodable parts, and slices are therefore elementary units for transmission. Some profiles of H.264/AVC enable the use of up to eight slice groups per coded picture. When more than one slice group is in use, the picture is partitioned into slice group map units, which are equal to two vertically consecutive macroblocks when the macroblock-adaptive frame-field (MBAFF) coding is in use and are equal to a macroblock when MBAFF coding is not in use. The picture parameter set contains data based on which each slice group map unit of a picture is associated to a particular slice group. A slice group can contain any slice group map units, including non-adjacent map units. When more than one slice group is specified for a picture, the flexible macroblock ordering (FMO) feature of the standard is used.

In H.264/AVC, a slice comprises one or more consecutive macroblocks (or macroblock pairs, when MBAFF is in use) within a particular slice group in raster scan order. If only one slice group is in use, then H.264/AVC slices contain consecutive macroblocks in raster scan order and are therefore similar to the slices in many previous coding standards.

An instantaneous decoding refresh (IDR) picture, specified in H.264/AVC, is coded picture that contains only slices with I or SI slice types that cause a “reset” in the decoding process. After an IDR picture is decoded, all coded pictures that follow in decoding order can be decoded without inter prediction from any picture that was decoded prior to the IDR picture.

Scalable media is typically ordered into hierarchical layers of data, where a video signal can be encoded into a base layer and one or more enhancement layers. A base layer can contain an individual representation of a coded media stream such as a video sequence. Enhancement layers can contain refinement data relative to previous layers in the layer hierarchy. The quality of the decoded media stream progressively improves as enhancement layers are added to the base layer. An enhancement layer enhances the temporal resolution (i.e., the frame rate), the spatial resolution, and/or simply the quality of the video content represented by another layer or part thereof. Each layer, together with all of its dependent layers, is one representation of the video signal at a certain spatial resolution, temporal resolution and/or quality level. Therefore, the term “scalable layer representation” is used herein to describe a scalable layer together with all of its dependent layers. The portion of a scalable bitstream corresponding to a scalable layer representation can be extracted and decoded to produce a representation of the original signal at a certain fidelity.

In H.264/AVC, SVC and MVC, temporal scalability can be achieved by using non-reference pictures and/or hierarchical inter-picture prediction structure described in greater detail below. It should be noted that by using only non-reference pictures, it is possible to achieve similar temporal scalability as that achieved by using conventional B pictures in MPEG-1/2/4. This can be accomplished by discarding non-reference pictures. Alternatively, use of a hierarchical coding structure can achieve more flexible temporal scalability.

FIG. 1 illustrates a conventional hierarchical coding structure with four levels of temporal scalability. A display order is indicated by the values denoted as picture order count (POC). The I or P pictures, also referred to as key pictures, are coded as a first picture of a group of pictures (GOPs) in decoding order. When a key picture is inter coded, the previous key pictures are used as a reference for inter-picture prediction. Therefore, these pictures correspond to the lowest temporal level (denoted as TL in FIG. 1) in the temporal scalable structure and are associated with the lowest frame rate. It should be noted that pictures of a higher temporal level may only use pictures of the same or lower temporal level for inter-picture prediction. With such a hierarchical coding structure, different temporal scalability corresponding to different frame rates can be achieved by discarding pictures of a certain temporal level value and beyond.

For example, referring back to FIG. 1, pictures 0, 108, and 116 are of the lowest temporal level, i.e., TL 0, while pictures 101, 103, 105, 107, 109, 111, 113, and 115 are of the highest temporal level, i.e., TL 3. The remaining pictures 102, 106, 110, and 114 are assigned to another TL in hierarchical fashion and compose a bitstream of a different frame rate. It should be noted that by decoding all of the temporal levels in a GOP, for example, a frame rate of 30 Hz can be achieved. Other frame rates can also be obtained by discarding pictures of certain other temporal levels. In addition, the pictures of the lowest temporal level can be associated with a frame rate of 3.25 Hz. It should be noted that a temporal scalable layer with a lower temporal level or a lower frame rate can also be referred to as a lower temporal level.

The hierarchical B picture coding structure described above is a typical coding structure for temporal scalability. However, it should be noted that more flexible coding structures are possible. For example, the GOP size does not have to be constant over time. Alternatively still, temporal enhancement layer pictures do not have to be coded as B slices, but rather may be coded as P slices.

Conventionally, broadcast/multicast media streams have included regular I or IDR pictures in order to provide a mechanism by which recipients can randomly access or “tune in” to the media stream. One system for providing a fast channel change response time is described in J. M. Boyce and A. M. Tourapis, “Fast efficient channel change,” in Proc. of IEEE Int. Con. on Consumer Electronics (ICCE), January 2005. This system and method involves the sending of a separate, low-quality intra picture stream to recipients for enabling fast tune-in. In this system, continuous transmission (without time-slicing) and no forward error correction over multiple pictures are assumed. However, a number of challenges arise from the use of a separate stream for tune-in. For example, there is currently no support in the Session Description Protocol (SDP) or its extensions for indicating the characteristics of the separate intra-picture stream or the relationship between a normal stream and the separate intra-picture stream. Additionally, such a system is not backwards-compatible; as a separate intra-picture stream requires dedicated signaling and processing by receivers, no receiver implemented according to the current standards can support the system. Still further, this system is incompatible with video coding standards. A video decoder implemented according to currently video coding standard is not capable of switching between two bitstreams without a complete reset of the decoding process. However, this system requires that the decoded picture buffer contains the decoded intra picture from the intra-picture stream, and the decoding would then continue seamlessly from the “normal” bitstream. This type of a stream switch in a decoder is not described in the current standards.

Another system for providing for improving faster tune-in is described in U.S. Patent Application Publication No. 2006/0107189, filed Oct. 5, 2005. In this system, a separate IDR picture stream is provided to the IP encapsulators, and the IP encapsulator replaces a “splicable” inter-coded picture in a normal bitstream with the corresponding picture in an IDR picture stream. The inserted IDR picture serves to reduce the tune-in delay. This system applies to time-sliced transmission, in which a network element replaces a picture in the “normal” bitstream with a picture from the IDR stream. However, the decoded sample values of these two pictures are not exactly the same. Due to inter prediction, this drift also propagates over time. The drift can be avoided by using SP pictures in the “normal” bitstream and replacing them with SI pictures. However, the SP/SI picture feature is not available in codecs other than H.264/AVC and is only available in one of the profiles of H.264/AVC. Furthermore, in order to reach or approach drift-free operation, the IDR/SI picture must be of the same quality than the replaced picture in the “normal” bitstream. Therefore, the method only suits a transmission system with time-slicing or large FEC blocks, in which the replacement is done relatively infrequently (once every two seconds of video data, for example).

Another system and method may be usable for fast tune-in when time-sliced transmission of video data and/or use of FEC over multiple pictures is used. In such a transmission arrangement, it is advantageous to have an IDR or intra picture as early as possible in the time-sliced burst or FEC block. To make use of the FEC protection, an entire FEC block must be received before decoding the media data. Consequently, the output duration of the pictures preceding the first IDR picture in the time-sliced or FEC block adds up to the tune-in delay. Otherwise (if the decoding started without this additional startup delay of the output duration of the pictures preceding the first IDR picture), there would be a pause in the playback as the next time-sliced burst or FEC block would not be completely received at the time when all of the data from the first time-sliced burst or FEC block is played out. IDR pictures can be aligned with time-sliced bursts and/or FEC block boundaries, when live real-time encoding is performed and the encoder has knowledge of the burst/FEC block boundaries. However, many systems do not facilitate such an encoder operation, as the encoder and time-slice/FEC encapsulation is typically performed in different devices, and there is typically no standard interface between these devices.

### SUMMARY OF THE INVENTION

Various embodiments provide a system and method by which IDR/intra pictures that enable one to tune in or randomly access a media stream are included within a coded video bitstream as redundant coded pictures. In these embodiments, each intra picture for tune-in is provided as a redundant coded picture, in addition to the corresponding primary inter-coded picture. The system and method of these various embodiments does not require any signaling support that is external to the video bitstream itself. The redundant coded picture is used for providing the pictures for fast tune-in, the various embodiments are also compatible with existing standards. The various embodiments described herein are also useful for both continuous transmission and time-sliced/FEC-protected transmission.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows a conventional hierarchical structure of four temporal scalable layers;

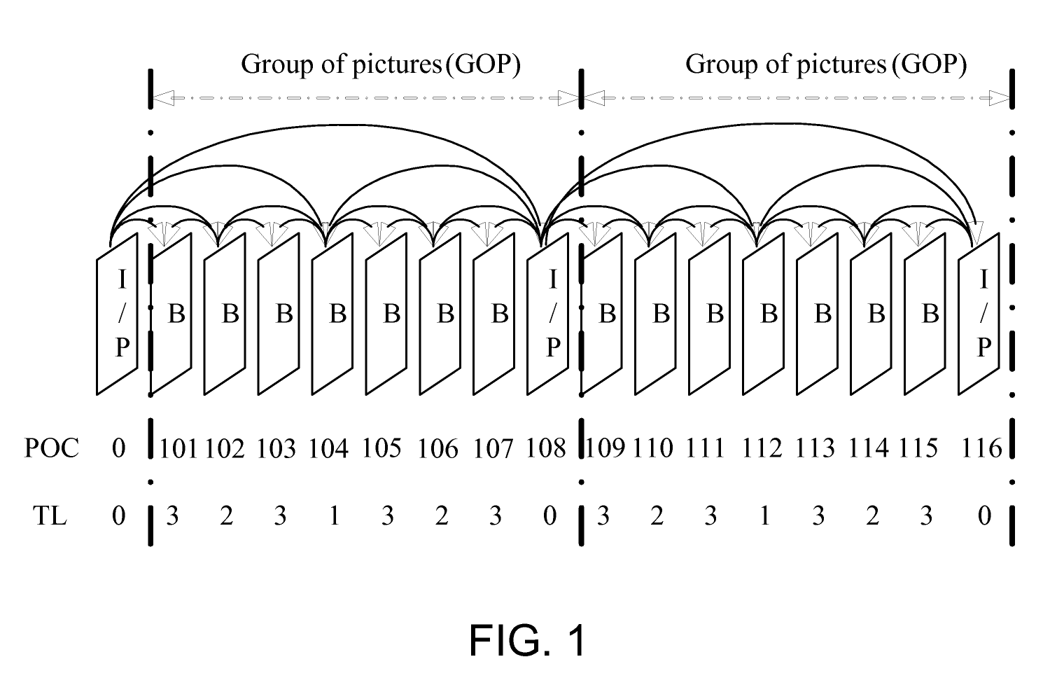

FIG. 2 shows a generic multimedia communications system for use with the present invention;

FIG. 3 is a representation of a media stream constructed in accordance with various embodiments of the present invention;

FIG. 4 is an overview diagram of a system within which various embodiments may be implemented;

FIG. 5 is a perspective view of an electronic device that can be used in conjunction with the implementation of various embodiments; and

FIG. 6 is a schematic representation of the circuitry which may be included in the electronic device of FIG. 5.

### DETAILED DESCRIPTION OF VARIOUS EMBODIMENTS

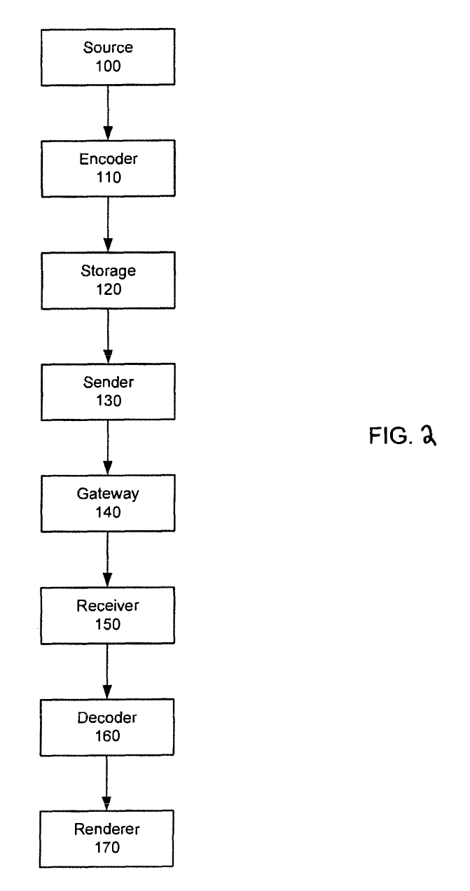

FIG. 2 shows a generic multimedia communications system for use with various embodiments of the present invention. As shown in FIG. 2, a data source 100 provides a source signal in an analog, uncompressed digital, or compressed digital format, or any combination of these formats. An encoder 110 encodes the source signal into a coded media bitstream. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. The encoder 110 may comprise a variety of hardware and/or software configurations. In the following, only processing of one coded media bitstream of one media type is considered to simplify the description. It should be noted, however, that typical real-time broadcast services comprise several streams (typically at least one audio, video and text sub-titling stream). It should also be noted that the system may include many encoders, but in the following only one encoder 110 is considered to simplify the description without a lack of generality.

It should be understood that, although text and examples contained herein may specifically describe an encoding process, one skilled in the art would readily understand that the same concepts and principles also apply to the corresponding decoding process and vice versa.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to a sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the sender 130 may reside in the same physical device or they may be included in separate devices. The encoder 110 and the sender 130 may operate with live real-time content, in which case the coded media bitstream is typically not stored permanently, but rather buffered for small periods of time in the content encoder 110 and/or in the sender 130 to smooth out variations in processing delay, transfer delay, and coded media bitrate.

The sender 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the sender 130 encapsulates the coded media bitstream into packets. For example, when RTP is used, the sender 130 encapsulates the coded media bitstream into RTP packets according to an RTP payload format. Typically, each media type has a dedicated RTP payload format. It should be again noted that a system may contain more than one sender 130, but for the sake of simplicity, the following description only considers one sender 130.

The sender 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer and acts as an endpoint of an RTP connection.

The system includes one or more receivers 150, typically capable of receiving, de-modulating, and de-capsulating the transmitted signal into a coded media bitstream. The codec media bitstream is typically processed further by a decoder 160, whose output is one or more uncompressed media streams. The decoder 160 may comprise a variety of hardware and/or software configurations. Finally, a renderer 170 may reproduce the uncompressed media streams with a loudspeaker or a display, for example. The receiver 150, the decoder 160, and the renderer 170 may reside in the same physical device or they may be included in separate devices.

It should be noted that the bitstream to be decoded can be received from a remote device located within virtually any type of network. Additionally, the bitstream can be received from local hardware or software.

Various embodiments provide a system and method by which IDR/intra pictures that enable one to tune in or randomly access a media stream are included within a coded video bitstream as redundant coded pictures. In these embodiments, each intra picture for tune-in is provided as a redundant coded picture, in addition to the corresponding primary inter-coded picture. The system and method of these various embodiments does not require any signaling support that is external to the video bitstream itself. The redundant coded picture is used for providing the pictures for fast tune-in, the various embodiments are also compatible with existing standards. The various embodiments described herein are also useful for both continuous transmission and time-sliced/FEC-protected transmission.

Various embodiments provide a method, computer program product and apparatus for encoding video into a video bitstream, comprising encoding a first picture into a primary coded representation of the first picture using inter picture prediction; encoding the first picture into a secondary coded representation of the first picture using intra picture prediction; and encoding a second picture succeeding the first picture in encoding order using inter picture prediction with reference to either the first picture or any other picture succeeding the first picture. A method, computer program product and apparatus for decoding video from a video bitstream comprises receiving a bitstream including at least two coded representations of a first picture, including a primary coded representation of the first picture using inter picture prediction and a secondary coded representation of the first picture using intra picture prediction; and starting to decode pictures in the bitstream by selectively decoding the secondary coded representation.

Various embodiments also provide a method, computer program product and apparatus for encoding video into a video bitstream, comprising encoding a bitstream with a temporal prediction hierarchy, wherein no picture in a lowest temporal level succeeding a first picture in decoding order is predicted from any picture preceding the first picture in decoding order; and encoding an intra-coded redundant coded picture corresponding to the first picture. A method, computer program product, and apparatus for decoding video from a video bitstream comprises receiving a bitstream with a temporal prediction hierarchy, wherein no picture in a lowest temporal level succeeding a first picture in decoding order is predicted from any picture preceding the first picture in decoding order; and starting to decode pictures in the bitstream by selectively decoding the first picture.

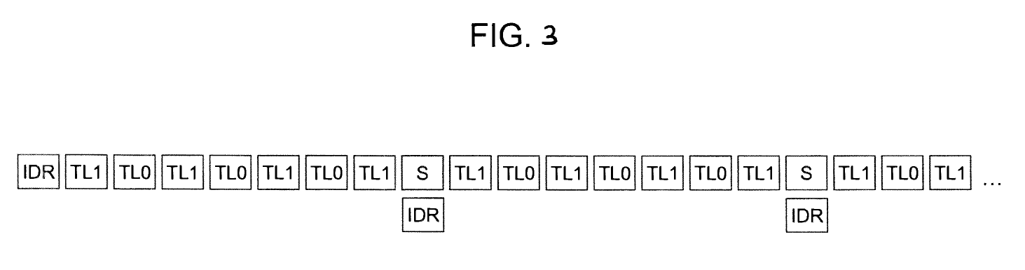

Various embodiments of the present invention may be implemented through the use of a video communication system of the type depicted in FIG. 2. Referring to FIGS. 2 and 3 and according to various embodiments, the encoder 110 creates a regular bitstream with any temporal prediction hierarchy, but with the following restriction: Every i^{th} picture (referred to herein as an S picture) relative to the previous primary IDR picture in temporal level 0 is coded in such a manner that no temporal level 0 picture succeeding the S picture in decoding order is inter-predicted from any picture preceding the S picture in decoding order. In FIG. 3, “TL0” refers to temporal level 0, and “TL1” refers to temporal level 1. The interval i can be predetermined and refers to the interval at which random access points are provided in the bitstream. The interval i can also vary and be adaptive within the bitstream. An S picture is a regular reference picture at temporal level 0 and can be of any coding type, such as P (inter-coded) or B (bi-predictively inter-coded). The encoder 110 also encodes an intra-coded redundant coded picture corresponding to each S picture. The redundant coded picture can be of lower quality (greater quantization step size) compared to the S picture.

According to one embodiment of the present invention, no picture at any temporal level or layer succeeding the S picture in decoding order is inter-predicted from any picture preceding the S picture in decoding order. Furthermore, the state of the decoded picture buffer (DPB) is reset after the decoding of the S picture, i.e., all reference pictures except for the S picture are marked as “unused for reference” and therefore cannot be used as reference pictures for inter prediction for any subsequent picture in decoding order. This can be accomplished in H.264/AVC and its extensions by including the memory management control operation 5 in the coded S picture. The intra-coded redundant coded picture can be marked as an IDR picture (with NAL unit type equal to 5).

According to another embodiment, a picture is included at a temporal level greater than 0 that succeeds the S picture in decoding order and is predicted from a picture preceding the S picture in decoding order.

According to still another embodiment, the encoder 110 additionally creates a recovery point SEI message enclosed in a nesting SEI message that indicates that the recovery point SEI message applies to the redundant coded picture. The nesting SEI message, various types of which are discussed in U.S. Provisional Patent Application No. 60/830,358 and filed on Jul. 11, 2006, can be pointed to a redundant picture. The recovery point SEI message indicates that the indicated redundant picture provides a random access point to the bitstream.

Various embodiments of the present invention can be applied to different types of transmission environments. Without limitation, various embodiments can be applied to the continuous transmission of video data (i.e., with no time-slicing) without FEC over multiple pictures. For example, DVB-T transmission using MPEG-2 transport stream falls into this category. For continuous transmission, the stream generated by the encoder 110 is delivered to the receiver 150 essentially without intentional changes.

Various embodiments can also be applied to cases involving the time-sliced transmission of video data and/or the use of FEC over multiple pictures. For example, DVB-H transmission and 3GPP Multimedia Broadcast/Multicast Service (MBMS) fall into this category. For time-sliced transmission or FEC over multiple pictures, at least one of the blocks performs the encapsulation to the time-sliced bursts and/or FEC blocks. For example, the encoder 110 may be further divided into two blocks—the media (video) encoder and the FEC encoder. The FEC encoder performs the encapsulation of the video bitstream to FEC blocks. The storage format of the file may support the pre-calculated FEC repair data (such as the FEC reservoir of Amendment 2 of the ISO base media file format, which is currently under development). Additionally, the server 130 may send the data in time-sliced bursts or perform the FEC encoding (including the media data encapsulation to FEC blocks). Still further, the gateway 140 may send the data in time-sliced bursts or perform the FEC encoding (including the media data encapsulation to FEC blocks). For example, the IP encapsulator of a DVB-H transmission system essentially divides the media data to time-sliced bursts and performs Reed-Solomon FEC encoding over each time-sliced burst.

The device or component performing the encapsulation to the time-sliced burst and/or FEC block also manipulates to the stream provided by the encoder 110 (and subsequently by the storage 120 and the server 130) such that at least some of the intra-coded redundant pictures subsequent to the first intra-coded redundant picture in decoding order in the time-sliced burst or FEC block are removed. In one embodiment, all of the intra-coded redundant pictures within the time-sliced burst or FEC block subsequent to the first intra-coded redundant picture in the time-sliced burst or FEC block are removed.

The receiver 160 starts decoding from the first primary IDR picture, the first primary picture indicated by the recovery point SEI message (which is not enclosed in a nesting SEI message), the first redundant IDR picture or the first redundant intra picture corresponding to an S picture (which may be indicated by a recovery point SEI message enclosed in a nesting SEI message as described above). Alternatively, the decoder 160 may start decoding from any picture, e.g. the first received picture, but then the decoded pictures may contain clearly visible errors. The decoder should therefore not output decoded pictures to the renderer 170 or indicate to the renderer 170 that pictures are not for rendering. The decoder 160 decodes the first redundant IDR picture or the first redundant intra picture corresponding to an S picture unless the preceding pictures are concluded to be correct in content (with an error tracking method capable of deducing when the entire picture is refreshed). The decoder starts outputting pictures or otherwise indicates to the renderer that pictures qualify for rendering at the first one of the following:

the first primary IDR picture is decoded;

the first primary picture at the recovery point indicated by the recovery point SEI message (which is not enclosed in a nesting SEI message);

the first redundant IDR picture;

the first redundant intra picture corresponding to an S picture; and

the first picture that is deduced to be correct by an error tracking method.

The redundant intra-coded pictures coded by the encoder 110 according to various embodiments can be used for random access in local playback of a bitstream. In addition to a seek operation, the random access feature can also be used to implement fast-forward or fast-backward playback (i.e. “trick modes” of operation). The bitstream for local playback may originate directly from the encoder 110 or storage 120, or the bitstream may be recorded by the receiver 150 or the decoder 160.

Various embodiments of the present invention are also applicable to a bitstream that is scalably coded, e.g. according to the scalable extension of H.264/AVC, also known as Scalable Video Coding (SVC). The encoder 110 may encode an intra-coded redundant picture for only some of the dependency_id values of an access unit. The decoder 160 may start decoding from a layer having a different value of dependency_id compared to that of the desired layer (for output), if an intra-coded redundant picture is available earlier in a layer that is not the desired layer.

Various embodiments of the present invention are also applicable in the context of a multi-view video bitstream. In this environment, the encoding and decoding of each view is performed as described above for single-view coding, with the exception that inter-view prediction may be used. In addition to intra-coded redundant pictures, redundant pictures that are inter-view predicted from a primary or redundant intra picture can be used for providing random access points.

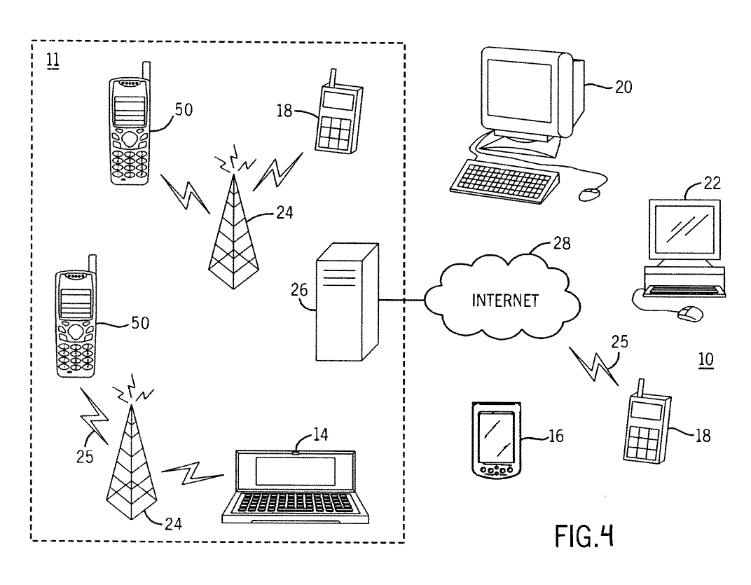

FIG. 4 shows a system 10 in which various embodiments can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 4 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile electronic device 50 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments may communicate using various media including, but not limited to, radio, infrared, laser, cable connection, and the like.

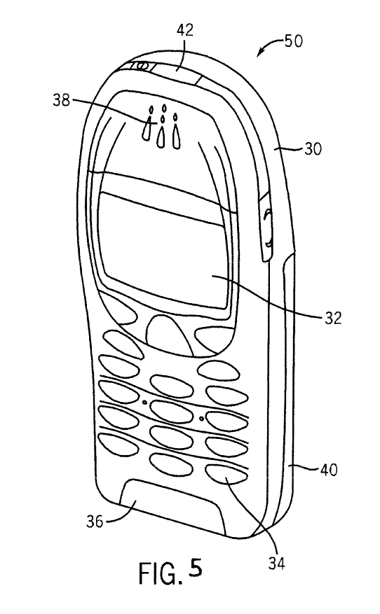

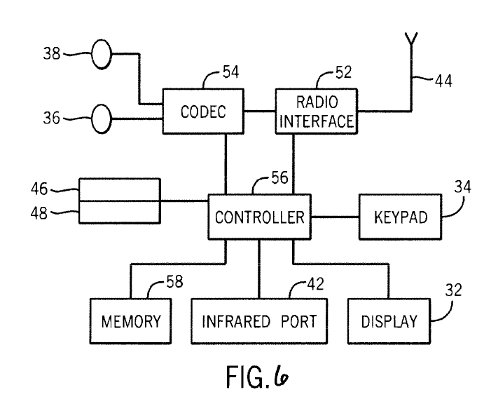

FIGS. 5 and 6 show one representative electronic device 50 within which various embodiments may be implemented. It should be understood, however, that the various embodiments are not intended to be limited to one particular type of device. The electronic device 50 of FIGS. 5 and 6 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art, for example in the Nokia range of mobile telephones.

The various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method of encoding video, comprising:
encoding a first picture into a primary coded representation of a first picture using inter picture prediction; and
encoding the first picture into a secondary coded representation of the first picture using intra picture prediction.

2. The method of claim 1, further comprising:
encoding into a bitstream a recovery point supplemental enhancement information message indicating that the secondary coded representation provides a random access point to the bitstream.

3. The method of claim 2, wherein the supplemental enhancement information message is enclosed in a nesting supplemental enhancement information message, the nesting supplemental enhancement information message indicating that the recovery point supplemental enhancement information message applies to the secondary coded representation.

4. The method of claim 2, wherein the bitstream is encoded with the use of forward error correction over multiple pictures.

5. The method of claim 1, further comprising:
encoding signaling information indicating whether a second picture succeeding the first picture in encoding order uses inter picture prediction with reference to a picture preceding the first picture in encoding order.

6. A computer program product, embodied in a computer-readable medium, comprising computer code configured to perform the processes of claim 1.

7. An apparatus, comprising:
an encoder configured to:
encode a first picture into a primary coded representation of a first picture using inter picture prediction; and
to encode the first picture into a secondary coded representation of the first picture using intra picture prediction.

8. The apparatus of claim 7, wherein the encoder is further configured to:
encode into a bitstream a recovery point supplemental enhancement information message indicating that the secondary coded representation provides a random access point to the bitstream.

9. The apparatus of claim 8, wherein the supplemental enhancement information message is enclosed in a nesting supplemental enhancement information message, the nesting supplemental enhancement information message indicating that the recovery point supplemental enhancement information message applies to the secondary coded representation.

10. The apparatus of claim 8, wherein the bitstream is encoded with the use of forward error correction over multiple pictures.

11. The apparatus of claim 7, wherein the encoder is further configured to:
encode signaling information indicating whether a second picture succeeding the first picture in encoding order uses inter picture prediction with reference to a picture preceding the first picture in encoding order.

12. An apparatus, comprising:
means for encoding a first picture into a primary coded representation of a first picture using inter picture prediction; and
means for encoding the first picture into a secondary coded representation of the first picture using intra picture prediction.

13. A method decoding encoded video, comprising:
receiving a bitstream including at least two coded representations of a first picture, including a primary coded representation of the first picture using inter picture prediction and a secondary coded representation of the first picture using intra picture prediction; and
starting to decode pictures in the bitstream by selectively decoding the secondary coded representation.

14. The method of claim 12, wherein the secondary coded representation comprises an instantaneous decoder refresh picture.

15. The method of claim 12, further comprising:
receiving a supplemental enhancement information message indicative of the secondary coded representation as a recovery point.

16. The method of claim 12, further comprising:
receiving signaling information indicating whether a second picture succeeding the first picture in encoding order uses inter picture prediction with reference to a picture preceding the first picture in encoding order.

17. A computer program product, embodied in a computer-readable medium, comprising computer code configured to perform the processes of claim 12.

18. An apparatus, comprising:
a decoder configured to:
receive a bitstream including at least two coded representations of a first picture, including a primary coded representation of the first picture using inter picture prediction and a secondary coded representation of the first picture using intra picture prediction; and
start to decode pictures in the bitstream by selectively decoding the secondary coded representation.

19. The apparatus of claim 18, wherein the secondary coded representation comprises an instantaneous decoder refresh picture.

20. The apparatus of claim 18, wherein the decoder is further configured to:
receive a supplemental enhancement information message indicative of the secondary coded representation as a recovery point.

21. The apparatus of claim 18, wherein the decoder is further configured to:
receive signaling information indicating whether a second picture succeeding the first picture in encoding order uses inter picture prediction with reference to a picture preceding the first picture in encoding order.

22. An apparatus, comprising:
means for receiving a bitstream including at least two coded representations of a first picture, including a primary coded representation of the first picture using inter picture prediction and a secondary coded representation of the first picture using intra picture prediction; and
means for starting to decode pictures in the bitstream by selectively decoding the secondary coded representation.
